(19) United States
(12) Patent Application Publication
(10) Pub. No.: US 2026/0276987 A1
(43) Pub. Date: Sep. 17, 2026

(54) Multiuser HUD for a Vehicle With an Accurate and Low-Loss Reflective Screen in the Projector-Based Imager

(71) Applicant: Bayerische Motoren Werke Aktiengesellschaft, Muenchen (DE)

(72) Inventors: Michael Arthur JANZER, Unterschleissheim (DE); Jasper STERN, Muenchen (DE)

(21) Appl. No.: 19/168,091

(22) PCT Filed: May 23, 2024
(86) PCT No.: PCT/DE2024/100477

§ 371 Date: Sep. 23, 2025

(30) Foreign Application Priority Data
May 26, 2023 (DE) 10 2023 113 886.3

(51) Int. Cl. G02B 27/01; G03B 21/58

(52) U.S. Cl. CPC G02B 27/0101; G03B 21/58

(57) ABSTRACT

A projection unit for a field of vision display device for superimposing a virtual image includes a projector-based imager with a projector for generating a beam of light with the desired display content and a projection screen illuminated by the beam. The projector is configured to generate a real image on the projection screen and the projection screen is configured to reflect the resulting light beam to the reflective screen. For this purpose, the projection screen has a mirror surface that is made up of a plurality of facets to form a facet grid with a sawtooth profile. Each facet has a first mirror segment for directed guidance of a first partial beam into a first user eyebox and a second mirror segment, angled relative to the first mirror segment, for directed guidance of a second partial beam into a second user eyebox.

### BACKGROUND AND SUMMARY

The invention relates to a projection unit for field-of-view display devices, which are known in motor vehicles or other land vehicles, aircraft, or water vehicles and are also known under the designation head-up display (HUD). They are used to generate a virtual image shown in the field of view of the user via reflection on a reflection pane, such as a windshield, rear window, or side window of the vehicle or a combiner pane separately provided for this purpose, in the field of view of the user. The invention is also directed to an associated production method and to the field-of-view display device and also to a vehicle equipped therewith.

Using a head-up display, for example, speed specifications and other useful navigation, warning, and vehicle operating instructions or also entertainment content are overlaid in the form of a virtual image on the real surroundings image in front of the vehicle which is observed by the driver and/or another occupant. Among other things, a simplified structural form of the HUD is known for generating a panoramic virtual display here, in which an image generator without further projection optics such as mirrors, etc. is positioned directly opposite to the windshield in its pane base area. The real image generated by the image generator is therefore reflected directly on the windshield and thus reaches the observers, such as a driver and/or front passenger.

The most obvious solution for generating a virtual image shown in the field of view of the driver using such a “mirror-less HUD” is placing an LCD (liquid crystal display) having a strong backlight below the windshield. Such an LCD-based mirror-less HUD has a disadvantage, however, that a substantial part of the light from the light source is already dissipated in the system before the reflection on the windshield: Typical LCDs only transmit 3 to 10% of the light from the light source with full white light display. With particularly bright displays, as are typically required in an HUD, this results in a correspondingly high energy consumption and sometimes in demanding thermal situations. Designing the positioning lever for bundling the HUD useful light on the relevant observation area (eye box) of a driver or front passenger proves to be difficult here above all in restricted installation space conditions in the vehicle.

Alternatively, it is possible to use a projection screen (also called a movie screen or screen) instead of an LCD, on which a projector projects a real image with high brightness. The most technically advanced projection solutions on the market are currently used in so-called “laser TVs”. An efficient laser diode in the projector forms the light source here. The projection screen is conceived here so that the largest possible proportion of the light coming from the projector is reflected in the direction of all spectators seated in front of the TV and the contrast is retained as much as possible at the same time in strong ambient light. A projector-based system offers the potential of significantly higher efficiency and higher thermal robustness in comparison to an LCD. However, such screens, which are known from the sector of “laser TVs” do not yet meet the demands for efficiency and contrast for use in an HUD. The potential of an observation area in the vehicle which is significantly smaller and more precisely definable in comparison to a TV as well as contrast retention measures due to a special insulation situation have not been exhausted. Up to this point, screens on the basis of volume holograms have offered the highest potentials in this direction. However, these have the disadvantage that they only exhaust their efficiency in a very narrowband wavelength range. The light of a projector has to be matched as exactly as possible thereto for the best possible efficiency. However, this proved to be difficult above all in the event of temperature variations, as often occur in the vehicle.

Furthermore, an HUD system for a motor vehicle having a facet-like screen is proposed in EP 2 594 987 A2 . The system comprises a standard vehicle window (i.e. without special coatings), an optical image projector, and an instrument panel, which is equipped with a reflective facet surface. The projector is designed to project an image on the reflective facet surface. This surface is designed to protect the projector image onto a surface of the standard vehicle window which is oriented so that it reflects the image from the reflective facet surface in the direction of an occupant. The reflective facet surface can be arranged within a plurality of troughs, which are separated from one another by a plurality of diffusely reflective separating walls. The plurality of troughs can be designed to shield the occupants from external reflections. In order to prevent the collection of dust and other dirt within the plurality of troughs during the vehicle life, they can be closed by a covered glass made of a transparent material such as acrylic. The reflective facet surface can comprise a reality of electrically actuatable facets, which is designed as an array of electro-wetting cells.

It is the object of the present invention to specify an alternative and/or improved projection unit for a field-of-view display device, which can be used in particular in a vehicle and is suitable in particular for a large-area and/or panoramic virtual image display via reflection on a windshield. This projection unit and field-of-view display device can enable an improvement in relation to known approaches, for example, with regard to the energy efficiency, production expenditure, costs, contrast, visibility for more than one user, image quality, and/or other aspects.

This object is achieved by a projection unit, an associated production method, a field-of-view display device containing this projection unit, and a vehicle equipped therewith according to the independent claims. Further designs are specified in the dependent claims. All refining features and effects mentioned in the claims and the following description for the projection unit also apply with respect to the production method, the field-of-view display device, and the motor vehicle and also vice versa in each case.

According to a first aspect, a projection unit for a field-of-view display device is provided, which can be designed in particular for use in a vehicle. The vehicle can be a motor vehicle, but also any other land vehicle, aircraft, or water vehicle. The field-of-view display device can be designed, for example, as a head-up display (HUD).

The projection unit is designed, in operation of the field-of-view display device, to output a light beam bundle, which is then reflected from a reflection pane arranged in the field of view of two or more users to their eyes or the eye boxes respectively predetermined for this purpose and thus a virtual image floating beyond the reflection pane is displayed to them. As is typical, a two-dimensional or three-dimensional spatial area, from which he can see the virtual image unrestrictedly, is understood as the eye box of the respective user of the field-of-view display device.

The respective eye box can have a two-dimensional extension of approximately 180 mm width (horizontal) and 120 mm height (vertical) herein, for example. The present field-of-view display device can have two or possibly also more eye boxes at a predetermined distance from one another for two or more different users (for example, for a driver and one or more from passengers, or for multiple passengers of the vehicle). The reflection pane can in particular be formed as a section of a windshield or another vehicle window or can be a combiner pane provided separately for this purpose. In operation of the field-of-view display device, it is arranged outside the projection unit, so that the projection unit can also be produced and sold separately from the reflection pane.

In this case, the projection unit comprises a projection-based image generator having a projector, which is designed to generate a light beam bundle having desired display content, and a projection screen (also called movie screen or screen) illuminated thereby in reflection. The projector is designed here to generate a real image on the projection screen, and the projection screen is designed to reflect the light beam bundle resulting therefrom in predetermined form and direction toward the reflection pane, in order to generate a virtual image having desired display properties for each of the users.

For this purpose, the projection screen comprises a mirror surface on its side facing toward the projector, which is assembled from a plurality of facets to form a facet grid having a sawtooth profile. Each facet has a first mirror element here, which is designed for a directed deflection of a first partial beam bundle of the incident light beam bundle into an eye box predetermined for the eyes of a first user. Furthermore, each facet has a second mirror element, which is designed for a directed deflection of a second partial beam bundle of the incident light beam bundle into an eye box predetermined for the eyes of a second user. For this purpose, the second mirror element is accordingly oriented angled in relation to the first mirror element, for example, with formation of an obtuse-angled kink in a rear side of the mirror surface that faces away from the projector. In an analogous manner, further mirror elements, which are each angled in relation to all other mirror segments of the same facet, for one or more further user eye boxes can be formed in each facet. The respective mirror segment can be designed for the purpose, for example, of deflecting the associated partial beam bundle into a center of the associated user eye box.

Due to such directed eye box illumination, the energy efficiency of the field-of-view display device having the projector-based image generator for two or more users can be substantially increased in comparison to the prior art. The respective mirror element can in particular be formed planar. Alternatively thereto, a curved design, for example, which is convex from the direction of the incident projector like, of the respective mirror segment can be expedient, for example, for particularly homogeneous illumination of the respective eye box.

The sawtooth profile can result here, inter alia, in that the mirror segments of the facet can each have different angles depending on the position on the facet grid or mirror array. Therefore, they do not always adjoin one another continuously, so that height offsets of adjacent facets are compensated for by transition surfaces oriented nearly perpendicularly to their mirror segments, due to which a sawtooth profile results. The surfaces of the individual facets can in particular be below a size that can be resolved using the human eye here, so that the facet grid is not recognizable for the user in the virtual image. The linear dimensions thereof can in particular be greater than the greatest wavelength of the projector light used in this case and can be, for example, in the micrometer range, in order to avoid interfering diffraction effects such as color fringes or interference, etc. The surfaces of the individual facets/mirror segments can moreover have sizes and/or forms varying among one another for the same purpose (cf., for example, FIG. 8b).

In particular, the dimensions of the individual facets in the mirror surface can be selected so that each pixel of the real image generated in the mirror surface extends over multiple, ideally at least four, facets. It can thus be ensured, inter alia, that the most equal possible parts of an incident projector light beam which generates a pixel are deflected into the individual user eye boxes.

According to one embodiment, the projection screen is designed flexibly or bendably such that it can be bent for adaptation of the mirror surface to various positions of the individual user eye boxes, in particular to various distances. If the adaptation has to be performed once, for example, during the installation of the projection unit in the vehicle for adaptation to its model-specific windshield form and location and specific front seat distances, the projection screen can be designed as not necessarily only elastic, but also plastically deformable for this purpose.

According to one embodiment, the projection screen comprises a platelike or filmlike transparent substrate on its side which faces toward the projector and on the rear side of which (i.e. the side facing away from the projector), the mirror surface is formed. It is therefore a projection screen having a refractive Fresnel optical unit in the form of a transparent substrate, on the rear side of which a mirror grid (called facet grid herein) is formed for a directed deflection of the light beam bundle into the two or more user eye boxes. This optically clear substrate made of a dielectric material ensures that even projector like incident very flatly on the substrate initially refracts in the substrate medium and is therefore incident on the facets at a steeper angle through the substrate. This makes it possible to keep the height of the facet relief lower and keep the efficiency of the system higher due to reduced light losses. At the same time, the substrate protects the sensitive mirror surface relief from scratches and other environmental influences such as moisture and dirt.

In particular, a diffuser can be arranged here in the interior of the substrate or on its front side facing toward the projector in the beam path of the light beam bundle incident on the mirror surface and its partial beam bundle reflected thereon, which diffuser is designed to expand the entire incident and reflected light beam bundle in total so that it fills up the entire respective eye box substantially uniformly and at the same time is also ideally substantially restricted to its area. At a typical optical path length from the projection screen to an eye box of approximately 1200 mm, for example, a diffuser having a full width at half maximum (FWHW) of approximately 5° to 10° is expedient for this purpose. A diffuser having a so-Attorney called flattop scattering characteristic would be particularly suitable in order to obtain the mentioned optimum illumination of each individual user eye box.

According to one embodiment, the projection screen furthermore has a cover layer on its rear side facing away from the projector, which covers the entire sawtooth profile of the facet grid (and therefore also the mirror surface) on the rear side and can be formed from a transparent material, in particular having the same index of refraction as the above substrate, or from a light-absorbing material. The undesired reflection of the light at the transition surfaces, which each extend transversely or perpendicularly to the facet surfaces between the adjacent facets, can best be prevented and the mirror surface can additionally be mechanically protected on the rear side.

According to a further aspect, a method for producing a projection screen for the projection unit presented herein is provided, comprising the following steps, which can be supplemented by further (intermediate) steps.

Initially, in a first variant of the method, the above-mentioned platelike or filmlike transparent substrate is provided or produced, the rear side of which, which faces away or is to be faced away from the projector, has the above-mentioned sawtooth profile. The sawtooth profile is made up of a plurality of faceted surfaces, the shape of which corresponds to the future reflective facets of the mirror surface, and transition surfaces connecting them. As also mentioned above, the transition surfaces each extend transversely to the faceted surfaces.

In a second variant of the method alternative thereto, in which the projection screen is to be produced without the front-side substrate, in the first step, the above cover layer (for example, in the form of a film or plate) made of a light-absorbing material or made of a transparent material is provided or produced so that its surface to be faced toward or facing toward the projector has a sawtooth profile, which is composed of a plurality of faceted surfaces and transition surfaces which connect them and which each extend transversely thereto. In this variant as well, the transition surfaces each extend transversely to the faceted surfaces of the future facets.

This is followed by directional coating of the substrate rear side (first variant) or the mentioned surface of the cover layer (second variant) using a thin metal layer or another light-reflecting material to form reflective facets on the faceted surfaces. The coating direction is selected here so that the transition surfaces are concealed like undercuts by the faceted surfaces, in other words stand in their shadows, and are therefore not also coated. Due to this alignment of the material jet, only the faceted surfaces are therefore coated using the light-reflecting material such as metal, etc. in a manner which is optimum for the optical functionality and saves material at the same time. The transition surfaces, which are not to contribute to the mirror surface, remain uncoated here, due to which undesired light reflections thereon are already substantially suppressed. This effect can additionally be reinforced by a suitable optical design of the optional cover layer in the first variant, as described above.

According to a further aspect, a field-of-view display device is provided, which can be designed in particular for use (i.e. installation) in a vehicle. In addition to the projection unit presented here, the field-of-view display device also comprises a reflection pane, which is arranged in the beam path of all partial beam bundles output by the projection unit and is reflective on the user side, and which can be designed, for example, as a section of a vehicle window or as a combiner pane provided separately. The reflection pane is arranged in the field of view of the two or more users and designed here so that it reflects the mentioned partial beam bundles to the associated eye boxes predetermined for the eyes of the respective users, due to which the display content is displayable thereto in the form of a virtual image beyond the reflection pane and is also displayed in operation of the field-of-view display device.

According to one embodiment, the reflection pane is arranged directly opposite to the projection screen, with the exception of possible covers of the projection unit (for example, in the form of a cover plate transmitting the light beam bundle), which do not have a beamforming, deflecting, or imaging optical effect on the light beam bundle. In other words, in this specific embodiment, the field-of-view display device does not comprise any further optical elements such as deflection mirrors or concave mirrors or lenses, etc. in the beam path of the light beam bundle between the projection screen and the reflection pane. Any coatings of the projection screen or the reflection pane having optical functionality are still possible here, however. In particular, a projection unit which is particularly compact in the vertical direction can be implemented using this embodiment, which is therefore particularly well suitable in particular even for a large-area virtual displays such as a panoramic display.

According to a further aspect, the above-mentioned vehicle is provided. The spatial orientation terms used herein such as “above”, “below”, “laterally”, “horizontally”, “vertically”, etc. refer in this case to the typical vehicle-fixed Cartesian coordinate system having longitudinal, transverse, and vertical axes of the vehicle perpendicular to one another. The vehicle has, for example, at least one vehicle window, such as a windshield having an instrument panel extending underneath, and a passenger compartment partially thus delimited. It is equipped with the above field-of-view display device, the projection unit of which can be installed, for example, directly in or below an upper side of the instrument panel, so that the light beam bundle in the form of two or more partial beam bundles is projected by the projection unit on the windshield or a combiner pane arranged directly in the field of view of the driver and/or one or more occupants, which is used as the above-mentioned reflection pane of the field-of-view display device. The field-of-view display device can also be integrated at any other suitable installation location in the vehicle, wherein other vehicle windows or combiner panes arranged at other points in the passenger compartment can also be used as reflection panes.

The above aspects of the invention and the embodiment and specific designs thereof will be explained in more detail hereinafter on the basis of examples shown in the appended drawings. The drawings are to be understood as schematic illustrations of the fundamental optical design principle, i.e. as not to scale.

### BRIEF DESCRIPTION OF THE DRAWINGS

FIG. 1 shows a detail of a vehicle having a field-of-view display device according to an exemplary embodiment of the invention in a perspective view.

FIG. 2 shows a perspective view of a detail of a projection screen of FIG. 1, which shows its basic structure.

FIG. 3 shows a further enlarged detail of the projection screen of FIGS. 1 and 2 from another perspective.

FIGS. 4a-4d show a sequence of three production stages of the projection screen of FIG. 1 according to an exemplary embodiment of the method.

FIG. 5 shows an enlarged perspective detail view of a refinement of the projection screen.

FIG. 6 shows a further perspective view of a detail of the vehicle as in FIG. 1, in which the field view display device is equipped with the projection screen of FIG. 5 according to a further exemplary embodiment of the invention.

FIGS. 7a-7b each show a top view of a field-of-view display device according to a specific exemplary embodiment of the invention, in which the projection screen can be elastically bent for adaptation to different eye box distances.

FIGS. 8a-8b each show a top view of a projection screen of a field-of-view display device according to an exemplary embodiment of the invention having a regular (FIG. 8a) and an irregular (FIG. 8b) facet grid.

### DETAILED DESCRIPTION OF THE DRAWINGS

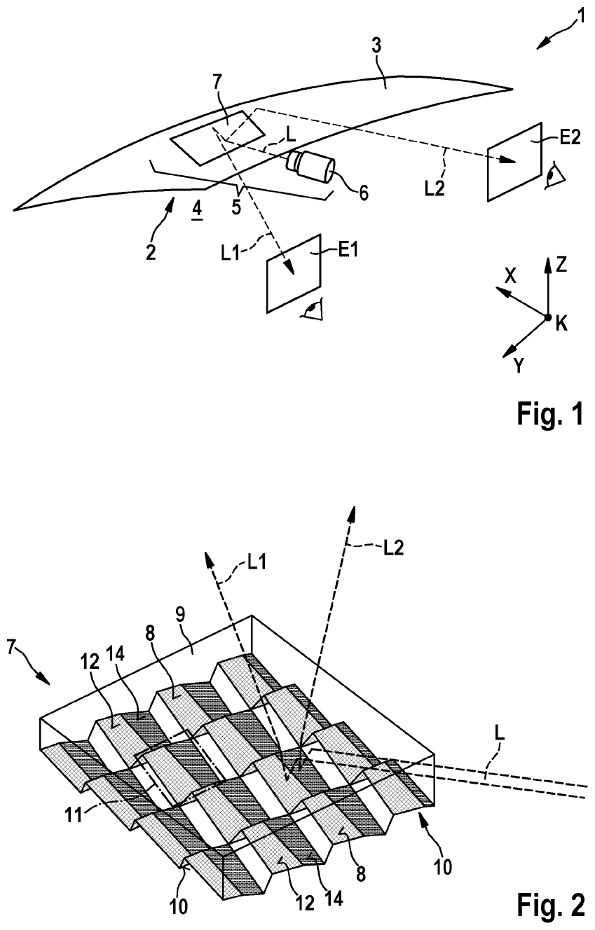

All further different embodiments, alternatives, and specific design features mentioned above in the description and in the following claims of the projection unit, the associated production method, the field-of-view display device, and the vehicle according to the above aspects of the invention can be implemented in the example shown in FIGS. 1 to 8b, in particular also alternatively or additionally to the features shown therein. Therefore, they are not all repeated once again hereinafter. The same applies accordingly to the further term definitions and effects already specified above with respect to individual features shown in FIGS. 1-8b.

FIG. 1 shows a greatly simplified perspective illustration diagonally from above of a detail of a vehicle 1 having a field-of-view display device 2 according to an exemplary embodiment of the invention. The spatial orientation terms used hereinafter such as “horizontal”, “vertical”, “above”, “below”, “underneath”, etc. relate to the typical vehicle-fixed Cartesian coordinate system K having longitudinal, transverse, and vertical directions X, Y, and Z of the vehicle 1 perpendicular to one another, wherein the longitudinal axis X points in the direction of travel as usual. The vehicle 1 is a motor vehicle in this example, which is only indicated by the windshield 3 and FIG. 1, which is used as the above-mentioned reflection pane of the field-of-view display device 2. A projection unit 5 of the field-of-view display device 2 is arranged underneath in an instrument panel 4 (not shown in more detail).

The field-of-view display device 2 is designed to generate a virtual image (not shown) in the field-of-view of two users in this example, a driver and a front passenger, who are each indicated in FIG. 1 only by their eyes and a spatial area (eye box) E1 or E2 predetermined for their eyes transversely to the respective beam propagation direction in the passenger compartment of the vehicle 1. The field-of-view display device 2 can be designed in particular for a panoramic virtual display in that the windshield 3 is used with a large part of its extension in the vehicle transverse direction Y as a reflection pane of the field-of-view display device 2. Solely by way of example, it is a head-up display (HUD).

The projection unit 5 contains a projector-based image generator. This comprises a projector 6, which is designed to generate a light beam bundle L (also called projector light herein) having desired display content, and a projection screen 7 (also called movie screen or screen) illuminated thereby. The light beam bundle L is indicated in FIG. 1 by its center beam, which leads from a center of the projector 6 into the center of the respective eye box E1 or E2. The projector 6 is designed to generate a real image on the projection screen 7 in reflection and therefore illuminates it diagonally from above.

FIG. 2 shows a perspective view of a basic structure of the projection screen 7 of FIG. 1 on the basis of an enlarged detail of the projection screen 7. The base of the projection screen 7 forms a mirror surface 8 in the form of a facet grid or mirror grid and, in this specific example, additionally a refracted Fresnel optical unit in the form of a transparent substrate 9, on the rear side 10 of which facing away from the projector 6 the facet grid is formed. The task of the mirror surface 8 is to deflect the light beam bundle L incident from the projector 6 in the direction of the windshield 3 and, via reflection thereon, into the center of the respective eye box E1/E2 of the two users. The mirror surface 8 is designed in this case to split the light beam bundle L and to guide one part (first partial beam bundle L1) into the eye box E1 of the driver and one part (second partial beam bundle L2) into the eye box E2 of the front passenger in each case.

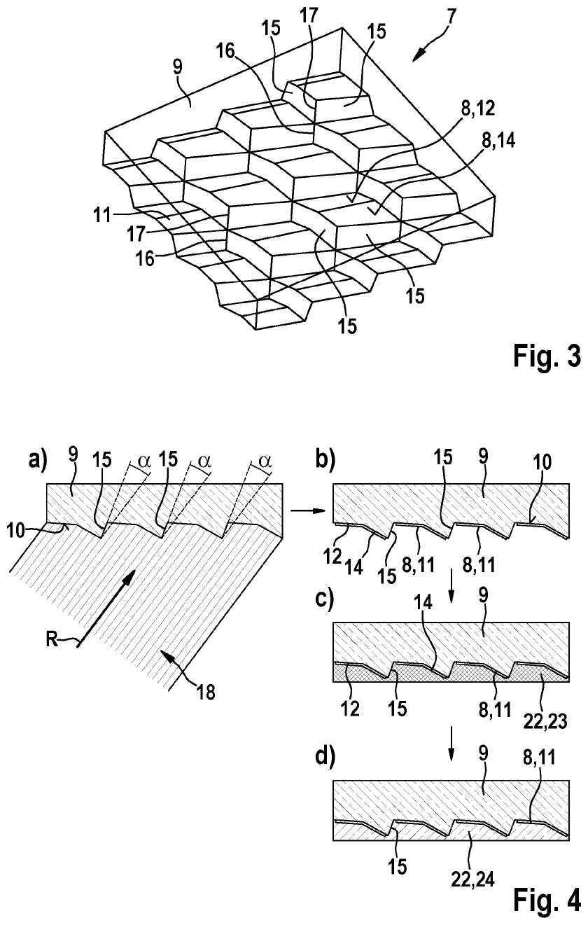

The projection screen 7 is designed here in this example to guide the light beam bundle L generated by the projector 6 as exactly as possible and with low loss via the windshield 3 into the eye boxes E1 and E2 of the two users, in order to enable the most efficient possible HUD system. The respective box E1, E2 is in this example in each case a field for the driver and the front passenger having an extension of approximately 180 mm width (measured horizontally) and 120 mm height (measured vertically). The amount of light is again to be distributed as homogeneously as possible in the eye boxes E1 and E2 thus defined, so that the eyes of the respective user can perceive the virtual image within the entire field with equal brightness. Refining or optional features of the projection screen 7, which can contribute to achieving this effect and other effects mentioned herein at other points, will be described hereinafter with reference to FIGS. 3 to 8b.

In FIG. 2 and in FIGS. 3-5 and 8a-b described hereinafter, only an enlarged detail of the projection screen 7 is shown in each case for illustration reasons. The entire mirror surface 8, i.e. the entire mirror grid or facet grid, in this example has approximately the extension of the desired real image projected by the projector 6 and consists of a plurality of facets 11. One of these facets 11 is highlighted in FIG. 2 by a frame which is shown.

Each facet 11 in turn consists of two mirror segments 12 and 14 in this example. The first mirror segment 12 is used for the reflection of incident projector light L into the driver eye box E1, the second mirror segment 12 is used for the reflection into the front passenger eye box E2. These segments 12 and 14, which are embodied as planar solely by way of example, therefore form an angle in relation to one another that can be seen in FIG. 2. It is a predetermined obtuse angle <180° when viewing the rear side of the respective facet 11, which is determined, inter alia, from the distance of the two eye boxes E1 and E2 from one another and the position of the respective facet 11 relative thereto.

It is therefore ensured that the most equal possible parts of an incident projector beam used to generate a single pixel are each guided into one eye box, if a facet 11 should be smaller than a corresponding projector beam cross-section or than a pixel, so that in the best case 4 or more facets are always hit simultaneously by such a beam. The facet grid is introduced onto the rear side 10 of the filmlike or platelike optically clear substrate 9 (dielectric material) in the favorable embodiment presented herein. This has the advantage that even projector light L incident very flatly on the substrate 9 first refracted in the dielectric medium and is then incident more steeply on the facets 11, as illustrated in FIG. 2. This helps, for example, to keep the height of the facet relief lower and the efficiency of the HUD system higher (or light losses lower). At the same time, the sensitive relief of the mirror surface 8 is protected from scratches by the substrate 9 arranged on the front side.

To maximize the reflection capacity of the facets 11, there rear sides can be provided with a metallic thin layer, for example, made of aluminum. Since the mirror segments 12, 14 of the facets 11 can have different angles or orientations depending on their position on the mirror array, the adjacent facets 11 do not always adjoin one another continuously. Height offsets of adjacent facets 11 have to be compensated for by transition surfaces 15, which are oriented, for example, nearly perpendicularly to the mirror segments 12, 14, in order to be struck as little as possible by the projector light L.

This is illustrated in FIG. 3, which shows a detail of the projection screen 7 of FIG. 2 in a likewise enlarged view from a different perspective than in FIG. 2 and permits a better view of the mentioned transition surfaces 15 between the individual facets 11 of the mirror surface 8. As can be seen in both FIGS. 1 and 2, an approximately sawtooth profile of the facet grid thus results overall.

These transition surfaces 15 and corners 16 and edges 17 which they form among one another could generate undesired back reflections of ambient light (such as sunlight) with an unfavorable design of their surfaces and could thus result in a contrast reduction in the virtual image or even in dazzling of the user. It is therefore particularly reasonable to embody these transition surfaces 15 and their edges 17 with as little reflectivity as possible. This is achieved in the production method presented herein in that the coating of the mirror segments 12 and 14 takes place directionally, as shown in FIG. 4a.

FIGS. 4a-d show an exemplary embodiment of the method presented herein for producing the projection screen 7 on the basis of a sequence of three production stages, which each show the projection screen 7 in an enlarged cross-sectional detail. The arrows shown between individual FIGS. 4a to 4c only illustrate the order of the method steps here.

FIG. 4a shows an example of the coating step here, in which the substrate 9 having a relief formed on its rear side 10, which geometrically corresponds to the sawtooth profile of the future facet grid, is directionally coated in a direction R shown using a light-reflecting material 18 (in this example metal). If the coating direction R is selected so that the transition surfaces 15 and the edges 17 thereof are located like undercuts in relation to the coating direction R (for example, as in FIG. 4a), they are not coated and the reflectivity of the surface thereof is not increased. With coating direction R thus selected, the transition surfaces 15 and the edges 17 thereof remain concealed by the surfaces of the future facets 11 protruding in a sawtooth shape. In other words, the transition surfaces 15 in this case form an acute spatial angle a in relation to the coating direction R, into which the material 18 does not reach, and which can be seen in FIG. 4a.

FIG. 4b shows the projection screen 7 after the completed coating step, so that the projection screen 7, as in FIGS. 2 and 3, has a mirror surface 8 formed on the rear side 10 of the substrate 9. This is assembled from a plurality of facets 11 to form a facet grid having a sawtooth profile, in which uncoated transition surfaces 15 extend between the reflectively coated facets 11.

As shown in FIG. 4c, a cover layer 22 (for example, as painting or potting) made of a light-absorbing material 23 can then be applied to the entire rear-side surface of the projection screen 7. The degree of absorption of the transition surfaces 15 and edges 17 thereof is thus additionally reduced, while the previously applied mirror surface 8 faces toward the substrate 9 and is thus protected from any further influence. Only the rear side thereof is coated using the light-absorbing material 23 in the step shown in FIG. 4c and thus additionally sealed or mechanically protected.

As shown in FIG. 4d, alternatively to FIG. 4c, the entire rear-side surface of the projection screen 7 of FIG. 4b can also be embedded using an optically clear or transparent material 24 in the form of a cover layer 22, which has the same index of refraction as the substrate 9. The undesired reflection at the transition surfaces 15 can thus also be prevented and the relief shown in FIG. 4b can be additionally mechanically protected.

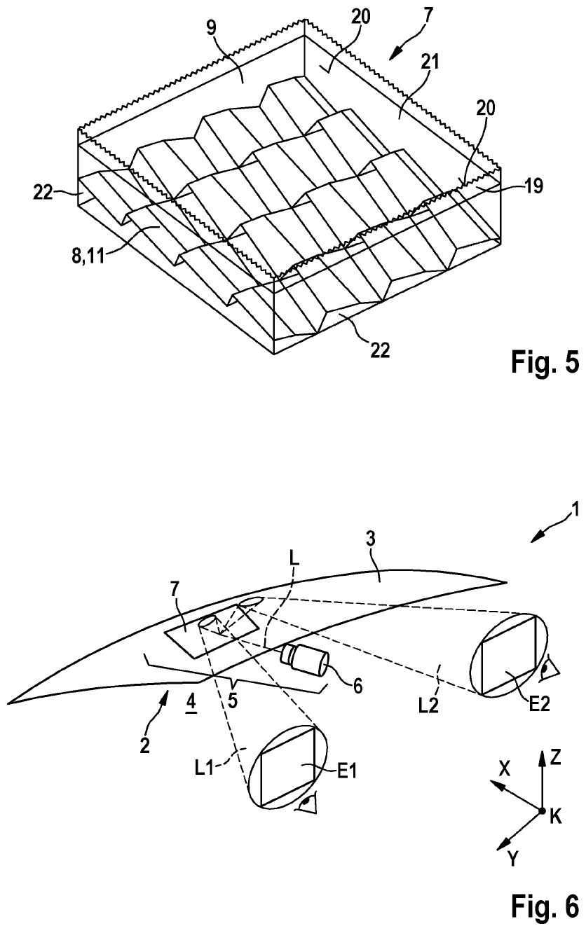

FIG. 5 shows an enlarged perspective detail illustration of a refinement of the projection screen 7. In addition to the elements of the projection screen 7 which were already described with reference to FIGS. 2-4d, a light diffuser 19 is arranged above the facet grid here in or on the substrate 9, which expands the incident and reflected projector beams L and L1/L2 in total so that instead of only striking the center point, they strike the entire eye box E1/E2 of the respective user as uniformly as possible, as illustrated in FIG. 6, for example.

At a distance from the projection screen 7 via the windshield 3 to the respective eye box E1 or E2 which is typical for motor vehicles and which is approximately 1200 mm, for this purpose, for example, a diffuser 19 having a full width at half maximum (FWHW) of 5°-10° is well suitable for this purpose. These values can accordingly be selected differently with other geometric conditions. It would be particularly reasonable to equip the diffuser 19 with a so-called flattop scattering characteristics for the mentioned angle range and thus to obtain optimum illumination of the eye box E1, E2. The diffuser 19 can either be implemented in an intermediary manner in the substrate 9 or directly by a corresponding surface composition of the substrate upper side (i.e. its front side 20 which faces toward the projector 6).

In one advantageous embodiment, this substrate upper side is additionally provided with an antireflective coating 21 in order to minimize reflections of ambient light and further increase the efficiency of the HUD system. The antireflective coating 21 is also to act as much as possible here for flat angles of incidence as occur with the incident projector beams L (cf. FIG. 2).

FIG. 6 shows, in a similar perspective illustration as in FIG. 1, a detail of a vehicle 1 having a field-of-view display device 2 according to a further exemplary embodiment of the invention, in which the projection screen 7 is equipped with a diffuser 19 according to FIG. 5. The respective partial light beam bundle L1 and L2 is indicated in FIG. 6 by its edge beams, which delimit its beam cross section required for the virtual image generation. A substantially uniform illumination of the respective eye box E1/E2, which is also essentially restricted to the area thereof, is achieved by a suitable selection of the diffuser 19, as described above.

Since the functionality of the projection screen 7 presented herein is similar at different wavelengths, it is suitable for a combination with a variety of projector types (such as laser beam scanner, DMD, etc . . . ). Moreover, the projection screen 7 does not change the polarization of the projector light L if the transparent dielectric material of its substrate 9 and the possibly provided antireflective coating 21 do not have birefringence. This is advantageous if the virtual image is also to be viewed using polarizing sunglasses.

In different vehicles 1, the extension of the driver and front passenger eye box E1/E2 only vary slightly. However, it can be the case that the lateral deflection of the projector beams L1, L2 by the projection screen 7 has to be embodied differently in different types and models of vehicles 1. This can be because of, on the one hand, different seat positions of the occupants in the vehicle 1 and, on the other hand, different transverse curvatures of the windshield 3.

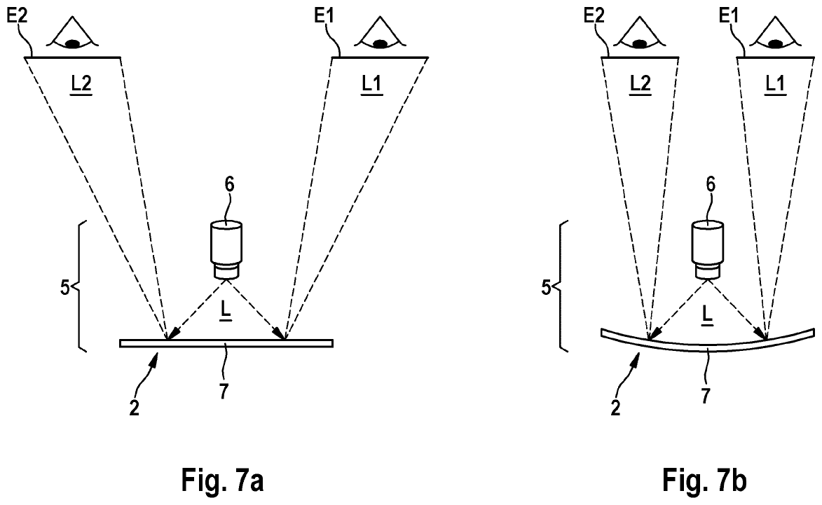

For this purpose, FIGS. 7a and 7b each show a top view of a field-of-view display device 2 according to a specific exemplary embodiment of the invention, in which the projection screen 7 presented herein is designed flexibly. In FIG. 7a, this can in particular be the field-of-view display device 2 according to FIG. 1 or 6. The projection screen 7 is aligned with its surface straight in FIG. 7a, for example, as also in FIGS. 2-5. The above-mentioned lateral light deflection of the projector beams L1, L2 by the projection screen 7 (cf. FIG. 1) can be adjusted matching for vehicles having eye boxes E1 and E2 arranged differently by a corresponding bend/curvature of the projection screen 7, in particular its elastic deformation, as shown in FIG. 7b. The two eye boxes E1 for the driver and E2 for the front passenger are significantly closer to one another here than in FIG. 7a, which can be compensated for by a corresponding curvature of the projection screen 7. A projection screen 7 having specific optics can thus be used for various types of vehicles 1.

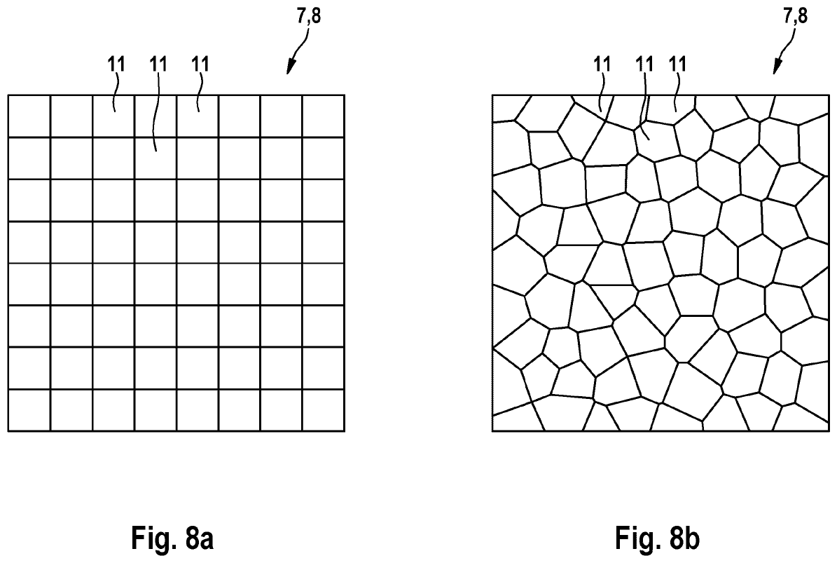

FIGS. 8a and 8b each show a schematic top view of a detail of the projection screen 7 of the field-of-view display device presented herein. It can be, for example, the field-of-view display device 2 of FIG. 1 or 6. In FIG. 8a, the individual facets 11 of its mirror surface 8 are arranged approximately regularly. As schematically indicated in FIG. 8b, they can alternatively be arranged in an irregular facet grid for reliable suppression of interfering diffraction effects (such as double images, color fringes, etc. due to constructive interference) or moiré effects.

### List of Reference Signs

1 vehicle
2 field-of-view display device
3 windshield
4 instrument panel
5 projection unit
6 projector
7 projection screen
8 mirror surface
9 transparent substrate
10 rear side of the substrate
11 facet
12, 14 first, second mirror segment
15 transition surface
16, 17 corner, edge
18 light-reflecting coating material, such as metal
19 diffuser
20 front side of the substrate
21 antireflective coating
22 cover layer
23 light-absorbing material
24 transparent material having the index of refraction of the substrate
L light beam bundle, also called projector light
L1, L2 first, second partial beam bundle
E1 eye box of a first user or driver eye box
E2 eye box of a second user or front passenger eye box
R coating direction
K vehicle-fixed Cartesian coordinate system
X, Y, Z longitudinal, transverse, and vertical directions of the vehicle

1.-10. (canceled)

11. A projection unit for a field-of-view display device, which is configured to show a virtual image via reflection on a reflection pane arranged in a field of view of two or more users, the projection unit comprising:
a projector-based image generator having a projector for generating a light beam bundle having desired display content and a projection screen illuminated thereby; wherein
the projector is configured for generating a real image on the projection screen and the projection screen is configured for reflecting the light beam bundle resulting from the projection screen toward the reflection pane;
the projection screen has a mirror surface for this purpose, which is assembled from a plurality of facets to form a facet grid having a sawtooth profile; and
each facet, for dividing the light beam bundle onto the two or more users, has at least a first mirror segment for a directed deflection of a first partial beam bundle into a first eye box predetermined for eyes of a first user and a second mirror segment, which is at an angle to the first mirror segment, for a directed deflection of a second partial beam bundle into a second eye box predetermined for eyes of a second user.

12. The projection unit according to claim 11, wherein
the reflection pane is a vehicle window.

13. The projection unit according to claim 11, wherein
dimensions of the individual facets in the mirror surface are selected so that each pixel of the real image generated in the mirror surface extends over multiple facets.

14. The projection unit according to claim 11, wherein
dimensions of the individual facets in the mirror surface are selected so that each pixel of the real image generated in the mirror surface extends over at least four facets.

15. The projection unit according to claim 11, wherein
the first mirror segment and the second mirror segment in each facet are angled in relation to one another to form an obtuse-angled kink in a rear side of the mirror surface that faces away from the projector.

16. The projection unit according to claim 11, wherein
the projection screen is flexible such that the projection screen is bendable for adaptation of the mirror surface to various positions of the first eye box and the second eye box.

17. The projection unit according to claim 11, wherein
the projection screen is flexible such that the projection screen is bendable for adaptation of the mirror surface to various distances between the first eye box and the second eye box.

18. The projection unit according to claim 11, wherein
the projection screen has a platelike or filmlike transparent substrate which faces toward the projector and on the rear side of which the mirror surface is formed.

19. The projection unit according to claim 18, wherein
a diffuser is arranged in an interior of the substrate or on a front side of the substrate facing toward the projector in a beam path of the light beam bundle incident and reflected on the mirror surface, which diffuser is configured to expand an incident and reflected light beam bundle in total so that the incident and reflected beam bundle fills an entire respective eye box substantially uniformly and is also substantially restricted here to an area of the respective eye box.

20. The projection unit according to claim 11, wherein
the projection screen has a cover layer on its rear side facing away from the projector, which cover layer covers the mirror surface and the entire sawtooth profile of the facet grid on the rear side and is formed from a light-absorbing material or from a transparent material.

21. The projection unit according to claim 20, wherein
the transparent material has a same index of refraction as the substrate.

22. A method for producing a projection screen for a projection unit, the method comprising:
providing a platelike or filmlike transparent substrate, the rear side of which is to be faced away from the projector and has a sawtooth profile, which is assembled from a plurality of faceted surfaces and transition surfaces which connect the faceted surfaces and which each extend transversely to the faceted surfaces; or
providing a cover layer made of a light-absorbing material or made of a transparent material, the surface of which is to be faced toward the projector and has a sawtooth profile, which is assembled from a plurality of faceted surfaces and transition surfaces which connect the faceted surfaces and which each extend transversely to the faceted surfaces; and
directionally coating the rear side of the substrate or the surface, to be faced toward the projector, of the cover layer using metal or another light-reflecting material in such a coating direction, for which the transition surfaces are in a shadow of the faceted surfaces and therefore are not coated to form reflective facets on the faceted surfaces.

23. A field-of-view display device for a vehicle, the field-of-view device comprising:
the projection unit according to claim 11; and
a reflection pane, which is arranged in the beam path of all partial beam bundles output by the projection unit and is reflected on a user side;
wherein the reflection pane is arranged in the field of view of the two or more users and configured such that the reflection pane reflects the partial beam bundles to the respective eye boxes, due to which the display content is displayable to the two or more users in each case in a form of a virtual image beyond the reflection pane.

24. The projection unit according to claim 23, wherein
the reflection pane is a vehicle window or a separately provided combiner pane.

25. The projection unit according to claim 23, wherein
the reflection pane is arranged directly opposite to the projection screen, with the exception of any covers of the projection unit which do not have a beamforming, deflecting, or imaging optical effect on the light beam bundle.

26. A vehicle comprising:
a vehicle window;
a passenger compartment partially delimited by the vehicle window; and
the field-of-view display device according to claim 23, the reflection pane of which is configured as part of the vehicle window or as a combiner pane arranged in the passenger compartment in the field of view of the respective user.

27. The field-of-view display device according to claim 26, wherein
the vehicle window is a windshield.
